(19) United States
(12) Patent Application Publication
(10) Pub. No.: US 2026/0161401 A1
(43) Pub. Date: Jun. 11, 2026

(54) THREAD COORDINATION DURING LARGE COMPUTER PROCESS SHUTDOWN

(71) Applicant: SAP SE, Walldorf (DE)

(72) Inventors: Robert Schneider, Heidelberg (DE); Roman Vinogradov, Walldorf (DE)

(21) Appl. No.: 18/970,129

(22) Filed: Dec. 5, 2024

(51) Int. Cl. G06F 9/30; G06F 9/4401; G06F 11/07

(52) U.S. Cl. CPC G06F 9/3009; G06F 9/442; G06F 11/0757

(57) ABSTRACT

In an example embodiment, a solution is provided that places all threads under control to prevent a scenario where a thread attempts to access memory that has already been released as part of a large computer system shutdown. While this solution address potential instability caused by a parallel processing shutdown technique, it can also be more broadly applied in any large computer system shutdown process to prevent crashes or other issues.

### TECHNICAL FIELD

This document generally relates to computer systems. More specifically, this document relates to thread coordination during large computer process shutdown.

### BACKGROUND

Large computer systems, such as databases, utilize a significant amount of memory resources. As a result, a shutdown of large processes within those large computer systems can be slow. For example, a large in-memory database may acquire a lot of resources and cache them for future usage. In certain instances, there may be a need to immediately shut down a large process, such as the control of the in-memory database, such as when an unrecoverable error occurs. In such instances, the operating system acts to clean up all remaining resources as fast as possible to be able to reallocate them to other processes.

### BRIEF DESCRIPTION OF DRAWINGS

The present disclosure is illustrated by way of example and not limitation in the figures of the accompanying drawings, in which like references indicate similar elements.

FIG. 1 is a block diagram of a system in which features consistent with the described subject matter may be implemented.

FIG. 2 is a flow diagram illustrating a method for shutting down a computer process, in accordance with an example embodiment.

FIG. 3 is a block diagram illustrating an architecture of software, in accordance with an example embodiment.

FIG. 4 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

In-memory databases such as SAP HANA™, from SAP SE of Walldorf, Germany, may utilize such a large quantity of computational and/or memory resources that the shutdown could take on the order of hours rather than seconds or minutes. For example, on a system having up to 48 TB of memory, the shutdown process can take 68 minutes. This becomes even more of an issue as the physical limits of databases grow from TBs to PBs. This increased time consumption is due to the operating system (e.g., Linux) freeing the resources using a single thread.

One solution would be to utilize concurrent parallel processing threads to free resources before the operating system takes over the process shutdown, rather than a single thread. Such a solution, however, may create instability. More specifically, this process only works if all execution threads are taken under full control prior to memory being released. Otherwise, if there is some thread that is not under full control (hereinafter called a “leaked thread”), then the shutdown process can crash or become stuck unexpectedly. This is because the leaked thread may continue its execution without being aware of the parallel memory release, and therefore attempting to access memory that has already been released.

In an example embodiment, a solution is provided that places all threads under control to prevent a scenario where a thread attempts to access memory that has already been released as part of a large computer process shutdown. While this solution addresses potential instability caused by a parallel processing shutdown technique, it can also be more broadly applied in any large computer process shutdown to prevent crashes or other issues.

The major reason why fast shutdown processes can create instability is that execution threads can themselves spawn new threads. This can result in a race condition where the parent thread is brought under control but only after the parent thread has spawned a new child thread. That new child thread is a leaked thread until it has also been brought under control. This can create a repeated cycle where the new thread is brought under control but only after it has spawned another thread, and so on and so on resulting in a scenario where there is always some thread not under control.

For example, in a parallel memory release process, a real-time signal can be used for inter-thread coordination, but this signal may be blocked in a newly spawned thread until that newly spawned thread is fully utilized. Thus, while the newly spawned thread is in this gestational phase it cannot be brought under control. This can be even more complicated because thread creation requires multiple steps by the parent thread. One of those steps is to check if thread creation is allowed. If this step has already passed, then the child thread will certainly be created. In Linux, this check is not the last step of thread creation. If the process decides to shut down, but the parent thread has already passed the thread creation check, then the new thread is not visible yet but will be spawned and there's no direct way known to prevent this. Such a child thread may become a leaked thread once it starts running. It can only receive a signal after it has started running.

A series of actions may be taken to address this technical use. First, before sending a signal to all known threads, the operating system may first disable the possibility of threads of a process being able to spawn new threads (e. g, create new processes, call a fork function, call a clone function, etc.). This may be accomplished by setting a resource limit to zero. In Linux this may involve setting the resource limit RLIMIT_NPROC to 0 via the setlimit system call This acts to at least limit the spread of leaked threads, but alone it is not enough since the parent thread may have already passed the resource limit check in its child thread creation routine.

As such, a dedicated signal is sent to all known threads of the current process. A signal handling function is introduced into threads when they are launched such that when the dedicated signal is received, the threads stop what they are doing and wait for a command from a coordinating thread to begin shutting down. The signal handling function waits until this signal is received to allow for the shutting down. In order to ensure that all the threads known to the operating system are iterated through, rather than taking them from some internal in-process registry of execution contexts/threads, threads are listed by asking the kernel directly for the thread list or by having thread identifiers be read from a special data structure that stores information about processes and other system information hierarchically. In Linux, this data structure is accessed using the proc filesystem (procfs). The read operation from procfs can be implemented in a signal safe manner. Procfs provides an interface to the internal data structure(s) about the running processes and threads in the Linux kernel. This reduces the threat of leaked threads even more, although there are still potential areas in which leaked threads can still emerge. This is because a new thread can appear and be made visible in procfs during the process by which procfs is being read. Thus, there is still a rare race condition that can exist.

More specifically, the existing criteria of the waiting logic can be based on two counters: the total number of threads obtained from procfs and the total number of threads that have received the signal. If after some period of time the number of threads that have received the signal so far is less than then total number of known threads, this means either that some threads just finished or that some new threads appeared, or both. In such a case, the technique is repeated another time. More specifically, a signal is again sent to all threads obtained from procfs. This repetition can continue until the number of threads that have received the signal so far is equal to the total number of known threads. This should handle any remaining leaked threads, with the exception of those caused by the rare race condition where a new thread can appear in procfs during the process by which procfs is being read.

If any thread is currently being spawned but not yet visible, then there must be a parent thread currently executing a clone( ) syscall. While the parent thread is executing this syscall, the parent thread is already visible in procfs but it cannot receive any signals because signals cannot be processed while syscalls occur. Therefore, if one were to wait for all currently known threads to respond to the signal, and one has finished waiting, then one knows that none of the responding threads are executing clone( ) syscalls anymore. If clone( ) has finished, then the child thread must already be visible in procfs.

Thus, the parent thread enters a clone( ) syscall, becoming unresponsive to signals. Then the parent thread checks RLIMIT_NPROC. The child thread becomes visible procfs. The parent thread then schedules the child thread and the parent thread exits the clone( ) syscall, becoming responsive to signals. The parent thread receives a signal and responds to it and the child thread must now be visible in procfs.

In another example embodiment, in order to prevent unexpected hanging from any cause, a signal-based watchdog timer can be created to notify the coordinating thread using a signal when the watchdog timer is timed out. In this way, the coordinating thread can decide what to do when not all threads can be taken under control. This watchdog timer can be signal-based (e.g., timer_create, sigev_notify=SIGEV SIGNAL_ID) to avoid thread creation.

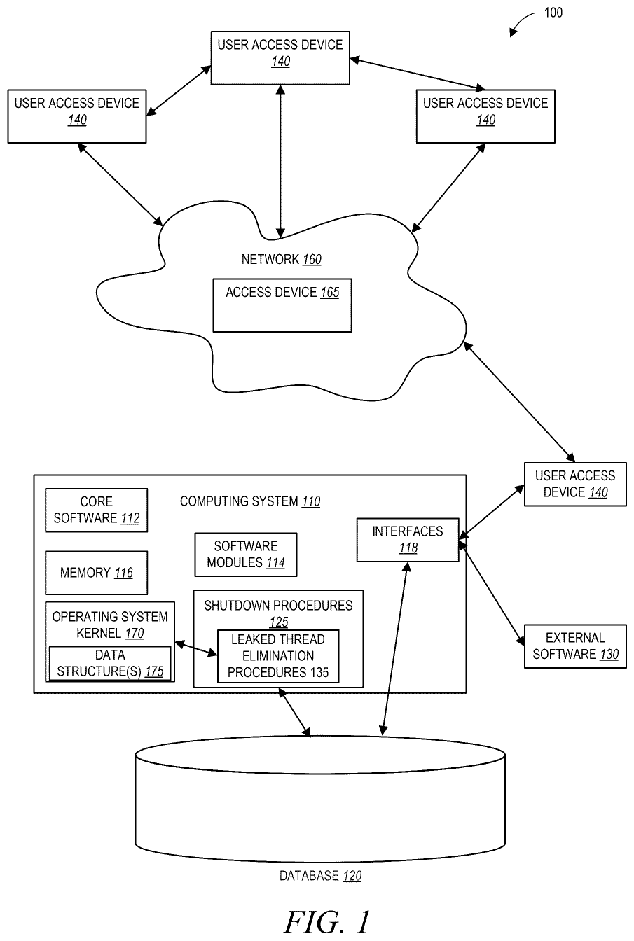

FIG. 1 is a block diagram of a system 100 in which features consistent with the described subject matter may be implemented. As illustrated, the system 100 may include a computing system 110 capable of communicating with one or more user access devices 140. The computing system 110 may utilize one or more interfaces 118 for communication. Communication among the devices of the system 100 may be through the use of direct communications, such as through the use of a wireless connection like Bluetooth, near-field communication (NFC), ZigBee, and/or the like, and/or a wired connection such as universal serial bus (USB) and/or the like. Communication may additionally or alternatively occur through indirect communications, such as over a network 160 (e.g., a local area network, a wide area network, a wireless network, the Internet, or the like).

Communication over the network 160 may utilize a network access device 165, such as a base station, a Node B, an evolved Node B (eNB), an access nodes (ANs), a hotspot, and/or the like. Any of the user access device 140 may include personal computers, desktop computers, laptops, workstations, cell phones, digital media devices, smart phones, smart watches, PDAs (personal digital assistants), tablets, hardware/software servers, sensors, sensor devices, terminals, access terminals (ATs), mobile stations, user equipment (UE), subscriber units, and/or the like.

As illustrated, the computing system 110 may include core software 112 and/or one or more software modules 114. The core software 112 may provide one or more features of a high-level programming software system. The software modules 114 may provide more specialized functionality. For example, the core software 112 and/or software modules 114 may include database management features, such as those described herein.

The core software 112 or other similar software/hardware may be capable of accessing a database layer, such as the database 120. It should be noted that while this embodiment depicts and describes the management of database 120, and specifically the shutdown of database 120, the techniques described herein are not limited specifically to the shutdown of databases but can apply to the shutdown procedures for any large computer process.

One or more of the software modules 114 may be configured to utilize data stored in the memory 116, data stored in the database 120, and/or data otherwise accessible to the computing system 110. As further illustrated, the computing system 110 may be capable of utilizing external software 130. The external software 130 may provide additional functionalities or services, which may not be available at the computing system 110. The external software 130 may include cloud services. The computing system 110 may aggregate or otherwise provide a gateway via which users may access functionality provided the external software 130. The database 120 and/or the external software 130 may be located across one or more servers, and/or communication among the computing system 110, the database, and/or the external software 130 may occur over the network 160.

At least a portion of the illustrated system 100 may include hardware and/or software that interacts with a database, users, and/or other software applications for defining, creating, and/or updating data, for receiving, handling, optimizing, and/or executing database queries, and/or for running software/applications (e.g., software modules 114, and/or external software 130) which utilize a database. The database 120 may be a structured, organized collection of data, such as schemas, tables, queries, reports, views, and/or the like, which may be processed for information. The database 120 may be physically stored in a hardware server or across a plurality of hardware servers. The database 120 may include a row store database, a column-store database, a schema-less database, or any other type of database. The computing system 110 may be configured to perform OLTP (online transaction processing) and/or OLAP (online analytical processing), which may include complex analytics and tasks. Any of the data stored in the database 120 may additionally or alternatively be stored in the memory 116, which may be required in order to process the data. As noted, a large accumulation of table data stored in the database 120 may affect the performance and/or resources of the memory 116, the core software 112, and/or a processor of the computing system 110.

The core software 112 may be configured to load the information from the database 120 to memory 116 (e.g., main memory) in response to some event and/or determination. For example, data may be retrieved from the database 120 and/or loaded into the memory 116 based on receipt of a query instantiated by a user or computer system, which may occur through one or more user access device 140, external software 130, and/or the like. At least a portion of the data for the database 120 may reside in-memory (e.g., in random-access memory (RAM)), within the memory 116, for example. Data stored in-memory may be accessed faster than data stored in long term storage (also referred to herein as “on disk”).

Although the database 120 may be illustrated as described as being separate from the computing system 110, in various implementations, at least a portion of the database 120 may be located within the memory 116 of the computing system 110.

The computing system 110 may implement shutdown procedures 125 for cleaning and clearing memory for a process shutdown. Prior to actually freeing physical memory, the shutdown procedures 125 may implement various leaked thread elimination procedures 135 to eliminate any possible leaked thread that could cause crashes during the shutting down of the database 120.

More specifically, the computing system 110 may additionally contain an operating system kernel 170, which itself includes data structure(s) 175 that is able to be exposed in a process-thread hierarchy, such as via a a procfs file system.

In order to quickly shut down the database 120, it may be beneficial to allocate the shutdown processing among multiple processing threads. For example, a database management system may have allocated memory (e.g., memory 116) and processing resources (e.g., core software 112) by an operating system of a computing system (e.g., computing system 110), and more specifically by operating system kernel 170. The database management system (e.g., SAP HANA) may include central processing unit (CPU) threads for executing database processes. The threads may allow application logic and/or processes to be separated into several concurrent execution paths. This feature may be useful when complex applications and/or processes have many tasks that can be performed at the same time.

As explained earlier, there is a risk that some of the threads spawned by the operating system kernel 170 are leaked threads. To combat this, the thread elimination procedures 135, which themselves may be launched in a controlling thread by the operating system kernel 170, act to cause all known threads to stop processing new threads. This may be accomplished by setting a resource limit of each known thread to zero. Then the thread elimination procedures 135 sends a dedicated signal to all known threads to halt processing and to wait for shut down instructions. When those threads were spawned, they included signal handling functions that detect the dedicated signal and then proceed to halt processing and wait for shut down instructions.

Then the thread elimination procedures 135 reads thread identities from the data structure(s) 175. This is performed in a signal safe manner. The thread elimination procedures 135 determine the total number of threads identified from the data structure(s) 175 and compares that number with the total number of threads that have received the dedicated signal. This latter number may be determined by, for example, the signal handling functions that detected the dedicated signal alerting the controlling thread that they received the dedicated signal, or by indirectly alerting the controlling thread by, for example, increasing a counter. If the totals do not match, then the dedicated signal is resent, and the totals are checked again. This repeats until the totals match.

Once that has been performed, the thread elimination procedures 135 check the data structure(s) 175 again to determine the total number of known threads. If that total did not change, then the thread elimination procedures 135 can cease functioning as all possible leaked threads have been handled. If the total did change, however, the sending of the dedicated signal and the iterative repeating of the comparing of the totals can be repeated again until the totals match. Once that occurs, then the thread elimination procedures 135 can cease functioning as all possible leaked threads have been handled.

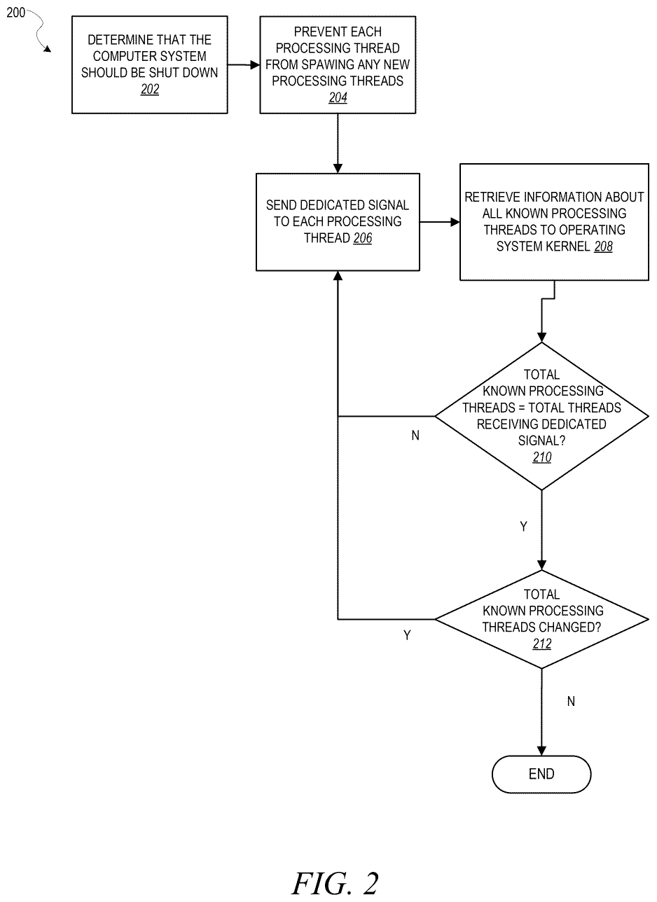

FIG. 2 is a flow diagram illustrating a method 200 for shutting down a computer process, in accordance with an example embodiment. At operation 202, it is determined that the computer process should be shut down. At operation 204, each processing thread of a plurality of processing threads are prevented from spawning any new processing threads. As mentioned before, this may be accomplished by setting a resource limit for each processing thread of an operating system kernel to zero. The result is that a resource check that occurs when beginning the process of spawning a new thread will cause that spawning to be cancelled.

At operation 206, a dedicated signal is sent to each processing thread of the plurality of processing threads. The dedicated signal indicates that each processing thread should stop current processing and wait for instructions. At operation 208, information about all processing threads known to an operating system kernel is retrieved, such as from data structure(s) in the operating system kernel. At operation 210, it is determined whether a total number of all processing threads known to the operating system kernel is equal to a total number of processing threads that received the dedicated signal. If not, then the method 200 loops to operation 206. If so, then at operation 212 it is determined whether the total number of all processing threads known to the operating system kernel has changed. If so, then the method 200 loops to operation 206. If not, then at operation 214 all processing threads known to are caused to shut down resources of the computer process.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising, based on a determination that a computer process should be shut down: preventing each processing thread of a plurality of processing threads from spawning any new processing threads; sending a dedicated signal to each processing thread of the plurality of processing threads, the dedicated signal indicating that each processing thread should stop current processing and wait for instructions; retrieving information about all processing threads known to an operating system kernel; determining whether a total number of all processing threads known to the operating system kernel is equal to a total number of processing threads that received the dedicated signal; in response to a determination that the total number of all processing threads known to the operating system kernel is equal to a total number of processing threads that received the dedicated signal, repeating the retrieving information about all processing threads known to the operating system kernel and determining whether the total number of all processing threads known to the operating system kernel has changed; and in response to a determination that the total number of all processing threads known to the operating system kernel has not changed, instructing all processing threads known to shut down resources of the computer process.

In Example 2, the subject matter of Example 1 comprises, wherein the computer process is a database process.

In Example 3, the subject matter of Example 2 comprises, wherein the database is an in-memory database.

In Example 4, the subject matter of Examples 1-3 comprises, wherein the operations are performed by one or more leaked thread elimination functions running on a controlling processing thread spawned by the operating system kernel.

In Example 5, the subject matter of Examples 1-4 comprises, wherein the instructing comprises instructing the all processing threads known to use using parallel processing to shut down the resources of the computer process.

In Example 6, the subject matter of Examples 1-5 comprises, wherein the operations further comprise: in response to a determination that the total number of all processing threads known to the operating system kernel is equal to a total number of processing threads that received the dedicated signal, repeating the sending, and retrieving until it is determined that the total number of all processing threads known to the operating system kernel is equal to a total number of processing threads that received the dedicated signal.

In Example 7, the subject matter of Examples 1-6 comprises, wherein the operations further comprise: in response to a determination that the total number of all processing threads known to the operating system kernel has changed, repeating, a single time, the sending, retrieving information about all processing threads known to the operating system kernel, determining whether a total number of all processing threads known to an operating system kernel is equal to a total number of processing threads that received the dedicated signal, and, in response to a determination that the total number of all processing threads known to the operating system kernel is equal to a total number of processing threads that received the dedicated signal, repeating the retrieving information about all processing threads known to the operating system kernel and determining whether the total number of all processing threads known to the operating system kernel has changed.

In Example 8, the subject matter of Examples 1-7 comprises, wherein the preventing comprises setting a resource limit of each processing thread in the plurality of processing threads to zero.

In Example 9, the subject matter of Examples 1-8 comprises, wherein each processing thread in the plurality of processing threads is spawned with one or more signal handling functions to interpret the dedicated signal.

In Example 10, the subject matter of Example 9 comprises, wherein the one or more signal handling functions further act to send an indication that a corresponding processing thread has received the dedicated signal and is halting processing.

In Example 11, the subject matter of Example 10 comprises, detecting when a watchdog timer indicates that one or more processing threads have failed to send the indication.

Example 12 is a method comprising, based on a determination that a computer process should be shut down: preventing each processing thread of a plurality of processing threads from spawning any new processing threads; sending a dedicated signal to each processing thread of the plurality of processing threads, the dedicated signal indicating that each processing thread should stop current processing and wait for instructions; retrieving information about all processing threads known to an operating system kernel; determining whether a total number of all processing threads known to the operating system kernel is equal to a total number of processing threads that received the dedicated signal; in response to a determination that the total number of all processing threads known to the operating system kernel is equal to a total number of processing threads that received the dedicated signal, repeating the retrieving information about all processing threads known to the operating system kernel and determining whether the total number of all processing threads known to the operating system kernel has changed; and in response to a determination that the total number of all processing threads known to the operating system kernel has not changed, instructing all processing threads known to shut down resources of the computer process.

In Example 13, the subject matter of Example 12 comprises, in response to a determination that the total number of all processing threads known to the operating system kernel is equal to a total number of processing threads that received the dedicated signal, repeating the sending, and retrieving until it is determined that the total number of all processing threads known to the operating system kernel is equal to a total number of processing threads that received the dedicated signal.

In Example 14, the subject matter of Examples 12-13 comprises, in response to a determination that the total number of all processing threads known to the operating system kernel has changed, repeating, a single time, the sending, retrieving information about all processing threads known to the operating system kernel, determining whether a total number of all processing threads known to an operating system kernel is equal to a total number of processing threads that received the dedicated signal, and, in response to a determination that the total number of all processing threads known to the operating system kernel is equal to a total number of processing threads that received the dedicated signal, repeating the retrieving information about all processing threads known to the operating system kernel and determining whether the total number of all processing threads known to the operating system kernel has changed.

In Example 15, the subject matter of Examples 12-14 comprises, wherein the preventing comprises setting a resource limit of each processing thread in the plurality of processing threads to zero.

In Example 16, the subject matter of Examples 12-15 comprises, wherein each processing thread in the plurality of processing threads is spawned with one or more signal handling functions to interpret the dedicated signal.

In Example 17, the subject matter of Example 16 comprises, wherein the one or more signal handling functions further act to send an indication that a corresponding processing thread has received the dedicated signal and is halting processing.

In Example 18, the subject matter of Example 17 comprises, detecting when a watchdog timer indicates that one or more processing threads have failed to send the indication.

Example 19 is a non-transitory machine-readable medium storing instructions which, when executed by one or more processors, cause the one or more processors to perform operations comprising based on a determination that a computer process should be shut down: preventing each processing thread of a plurality of processing threads from spawning any new processing threads; sending a dedicated signal to each processing thread of the plurality of processing threads, the dedicated signal indicating that each processing thread should stop current processing and wait for instructions; retrieving information about all processing threads known to an operating system kernel; determining whether a total number of all processing threads known to the operating system kernel is equal to a total number of processing threads that received the dedicated signal; in response to a determination that the total number of all processing threads known to the operating system kernel is equal to a total number of processing threads that received the dedicated signal, repeating the retrieving information about all processing threads known to the operating system kernel and determining whether the total number of all processing threads known to the operating system kernel has changed; and in response to a determination that the total number of all processing threads known to the operating system kernel has not changed, instructing all processing threads known to shut down resources of the computer process.

In Example 20, the subject matter of Example 19 comprises, wherein the computer process is a database process.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

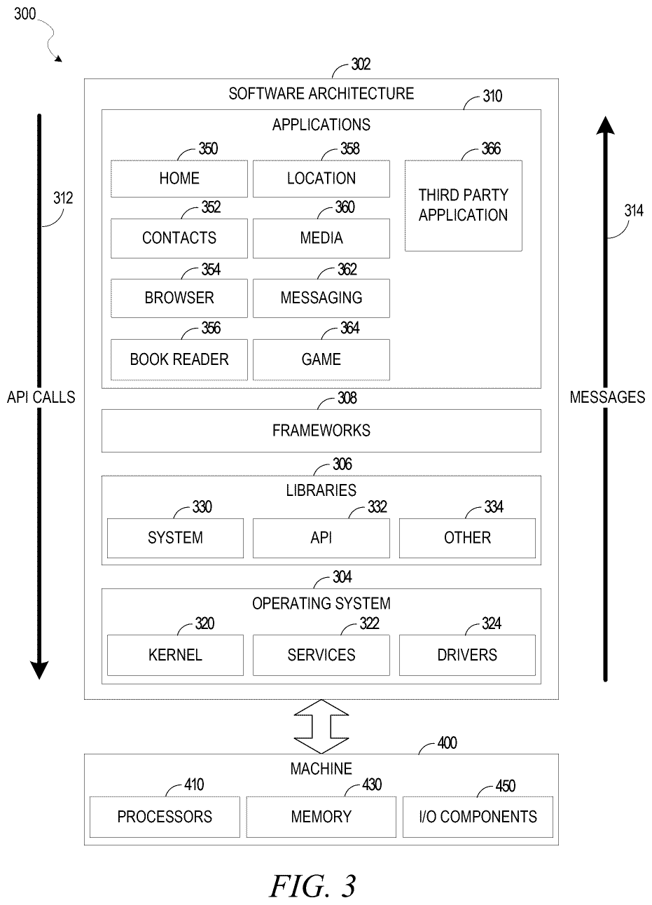

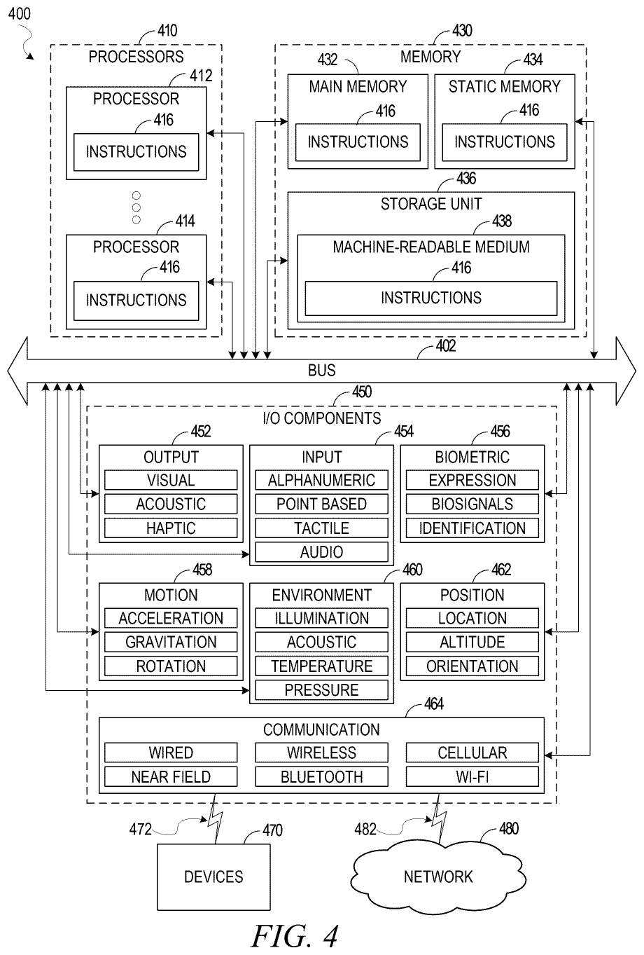

FIG. 3 is a block diagram 300 illustrating a software architecture 302, which can be installed on any one or more of the devices described above. FIG. 3 is merely a non-limiting example of a software architecture, and it will be appreciated that many other architectures can be implemented to facilitate the functionality described herein. In various embodiments, the software architecture 302 is implemented by hardware such as a machine 400 of FIG. 4 that includes processors 410, memory 430, and input/output (I/O) components 450. In this example architecture, the software architecture 302 can be conceptualized as a stack of layers where each layer may provide a particular functionality. For example, the software architecture 302 includes layers such as an operating system 304, libraries 306, frameworks 308, and applications 310. Operationally, the applications 310 invoke API calls 312 through the software stack and receive messages 314 in response to the API calls 312, consistent with some embodiments.

In various implementations, the operating system 304 manages hardware resources and provides common services. The operating system 304 includes, for example, a kernel 320, services 322, and drivers 324. The kernel 320 acts as an abstraction layer between the hardware and the other software layers, consistent with some embodiments. For example, the kernel 320 provides memory management, processor management (e.g., scheduling), component management, networking, and security settings, among other functionalities. The services 322 can provide other common services for the other software layers. The drivers 324 are responsible for controlling or interfacing with the underlying hardware, according to some embodiments. For instance, the drivers 324 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 306 provide a low-level common infrastructure utilized by the applications 310. The libraries 306 can include system libraries 330 (e.g., C standard library) that can provide functions such as memory allocation functions, string manipulation functions, mathematic functions, and the like. In addition, the libraries 306 can include API libraries 332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 306 can also include a wide variety of other libraries 334 to provide many other APIs to the applications 310.

The frameworks 308 provide a high-level common infrastructure that can be utilized by the applications 310, according to some embodiments. For example, the frameworks 308 provide various GUI functions, high-level resource management, high-level location services, and so forth. The frameworks 308 can provide a broad spectrum of other APIs that can be utilized by the applications 310, some of which may be specific to a particular operating system 304 or platform.

In an example embodiment, the applications 310 include a home application 350, a contacts application 352, a browser application 354, a book reader application 356, a location application 358, a media application 360, a messaging application 362, a game application 364, and a broad assortment of other applications, such as a third-party application 366. According to some embodiments, the applications 310 are programs that execute functions defined in the programs. Various programming languages can be employed to create one or more of the applications 310, structured in a variety of manners, such as object-oriented programming languages (e.g., Objective-C, Java, or C++) or procedural programming languages (e.g., C or assembly language). In a specific example, the third-party application 366 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 366 can invoke the API calls 312 provided by the operating system 304 to facilitate functionality described herein.

FIG. 4 illustrates a diagrammatic representation of a machine 400 in the form of a computer system within which a set of instructions may be executed for causing the machine 400 to perform any one or more of the methodologies discussed herein, according to an example embodiment. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein may be executed. For example, the instructions 416 may cause the machine 400 to execute the method 200 of FIG. 2. Additionally, or alternatively, the instructions 416 may implement FIGS. 1-2 and so forth. The instructions 416 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 may include processors 410, memory 430, and I/O components 450, which may be configured to communicate with each other such as via a bus 402. In an example embodiment, the processors 410 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 412 and a processor 414 that may execute the instructions 416. The term “processor” is intended to include multi-core processors that may comprise two or more independent processors (sometimes referred to as “cores”) that may execute instructions 416 contemporaneously. Although FIG. 4 shows multiple processors 410, the machine 400 may include a single processor 412 with a single core, a single processor 412 with multiple cores (e.g., a multi-core processor 412), multiple processors 412, 414 with a single core, multiple processors 412, 414 with multiple cores, or any combination thereof.

The memory 430 may include a main memory 432, a static memory 434, and a storage unit 436, each accessible to the processors 410 such as via the bus 402. The main memory 432, the static memory 434, and the storage unit 436 store the instructions 416 embodying any one or more of the methodologies or functions described herein. The instructions 416 may also reside, completely or partially, within machine-readable memory 438, main memory 432, within the static memory 434, within the storage unit 436, within at least one of the processors 410 (e.g., within the processor's cache memory), or any suitable combination thereof, during execution thereof by the machine 400.

The I/O components 450 may include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 may include many other components that are not shown in FIG. 4. The I/O components 450 are grouped according to functionality merely for simplifying the following discussion, and the grouping is in no way limiting. In various example embodiments, the I/O components 450 may include output components 452 and input components 454. The output components 452 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 454 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 450 may include biometric components 456, motion components 458, environmental components 460, or position components 462, among a wide array of other components. For example, the biometric components 456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 458 may include acceleration sensor components (e.g., accelerometer), gravitation sensor components, rotation sensor components (e.g., gyroscope), and so forth. The environmental components 460 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 462 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 450 may include communication components 464 operable to couple the machine 400 to a network 480 or devices 470 via a coupling 482 and a coupling 472, respectively. For example, the communication components 464 may include a network interface component or another suitable device to interface with the network 480. In further examples, the communication components 464 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 470 may be another machine or any of a wide variety of peripheral devices (e.g., coupled via a USB).

Moreover, the communication components 464 may detect identifiers or include components operable to detect identifiers. For example, the communication components 464 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 464, such as location via Internet Protocol (IP) geolocation, location via Wi-Fi® signal triangulation, location via detecting an NFC beacon signal that may indicate a particular location, and so forth.

The various memories (e.g., 430, 432, 434, and/or memory of the processor(s) 410) and/or the storage unit 436 may store one or more sets of instructions 416 and data structures (e.g., software) embodying or utilized by any one or more of the methodologies or functions described herein. These instructions (e.g., the instructions 416), when executed by the processor(s) 410, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 480 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 480 or a portion of the network 480 may include a wireless or cellular network, and the coupling 482 may be a Code Division Multiple Access (CDMA) connection, a Global System for Mobile communications (GSM) connection, or another type of cellular or wireless coupling. In this example, the coupling 482 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 416 may be transmitted or received over the network 480 using a transmission medium via a network interface device (e.g., a network interface component included in the communication components 464) and utilizing any one of a number of well-known transfer protocols (e.g., HTTP). Similarly, the instructions 416 may be transmitted or received using a transmission medium via the coupling 472 (e.g., a peer-to-peer coupling) to the devices 470. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 416 for execution by the machine 400, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising, based on a determination that a computer process is to be shut down:
preventing each processing thread of a plurality of processing threads from spawning any new processing threads;
sending a dedicated signal to each processing thread of the plurality of processing threads, the dedicated signal indicating that each processing thread should stop current processing and wait for instructions;
retrieving information about all processing threads known to an operating system kernel;
determining whether a total number of all processing threads known to the operating system kernel is equal to a total number of processing threads that received the dedicated signal;
in response to a determination that the total number of all processing threads known to the operating system kernel is equal to a total number of processing threads that received the dedicated signal, repeating the retrieving information about all processing threads known to the operating system kernel and determining whether the total number of all processing threads known to the operating system kernel has changed; and
in response to a determination that the total number of all processing threads known to the operating system kernel has not changed, instructing all processing threads known to shut down resources of the computer process.

2. The system of claim 1, wherein the computer process is a database process.

3. The system of claim 2, wherein the database is an in-memory database.

4. The system of claim 1, wherein the operations are performed by one or more leaked thread elimination functions running on a controlling processing thread spawned by the operating system kernel.

5. The system of claim 1, wherein the instructing comprises instructing the all processing threads known to use using parallel processing to shut down the resources of the computer process.

6. The system of claim 1, wherein the operations further comprise:
in response to a determination that the total number of all processing threads known to the operating system kernel is equal to a total number of processing threads that received the dedicated signal, repeating the sending, and retrieving until it is determined that the total number of all processing threads known to the operating system kernel is equal to a total number of processing threads that received the dedicated signal.

7. The system of claim 1, wherein the operations further comprise:
in response to a determination that the total number of all processing threads known to the operating system kernel has changed, repeating, a single time, the sending, retrieving information about all processing threads known to the operating system kernel, determining whether a total number of all processing threads known to an operating system kernel is equal to a total number of processing threads that received the dedicated signal, and, in response to a determination that the total number of all processing threads known to the operating system kernel is equal to a total number of processing threads that received the dedicated signal, repeating the retrieving information about all processing threads known to the operating system kernel and determining whether the total number of all processing threads known to the operating system kernel has changed.

8. The system of claim 1, wherein the preventing comprises setting a resource limit of each processing thread in the plurality of processing threads to zero.

9. The system of claim 1, wherein each processing thread in the plurality of processing threads is spawned with one or more signal handling functions to interpret the dedicated signal.

10. The system of claim 9, wherein the one or more signal handling functions further act to send an indication that a corresponding processing thread has received the dedicated signal and is halting processing.

11. The system of claim 10, further comprising detecting when a watchdog timer indicates that one or more processing threads have failed to send the indication.

12. A method comprising, based on a determination that a computer process should be shut down:
preventing each processing thread of a plurality of processing threads from spawning any new processing threads;
sending a dedicated signal to each processing thread of the plurality of processing threads, the dedicated signal indicating that each processing thread should stop current processing and wait for instructions;
retrieving information about all processing threads known to an operating system kernel;
determining whether a total number of all processing threads known to the operating system kernel is equal to a total number of processing threads that received the dedicated signal;
in response to a determination that the total number of all processing threads known to the operating system kernel is equal to a total number of processing threads that received the dedicated signal, repeating the retrieving information about all processing threads known to the operating system kernel and determining whether the total number of all processing threads known to the operating system kernel has changed; and
in response to a determination that the total number of all processing threads known to the operating system kernel has not changed, instructing all processing threads known to shut down resources of the computer process.

13. The method of claim 12, further comprising:
in response to a determination that the total number of all processing threads known to the operating system kernel is equal to a total number of processing threads that received the dedicated signal, repeating the sending, and retrieving until it is determined that the total number of all processing threads known to the operating system kernel is equal to a total number of processing threads that received the dedicated signal.

14. The method of claim 12, further comprising:
in response to a determination that the total number of all processing threads known to the operating system kernel has changed, repeating, a single time, the sending, retrieving information about all processing threads known to the operating system kernel, determining whether a total number of all processing threads known to an operating system kernel is equal to a total number of processing threads that received the dedicated signal, and, in response to a determination that the total number of all processing threads known to the operating system kernel is equal to a total number of processing threads that received the dedicated signal, repeating the retrieving information about all processing threads known to the operating system kernel and determining whether the total number of all processing threads known to the operating system kernel has changed.

15. The method of claim 12, wherein the preventing comprises setting a resource limit of each processing thread in the plurality of processing threads to zero.

16. The method of claim 12, wherein each processing thread in the plurality of processing threads is spawned with one or more signal handling functions to interpret the dedicated signal.

17. The method of claim 16, wherein the one or more signal handling functions further act to send an indication that a corresponding processing thread has received the dedicated signal and is halting processing.

18. The method of claim 17, further comprising detecting when a watchdog timer indicates that one or more processing threads have failed to send the indication.

19. A non-transitory machine-readable medium storing instructions which, when executed by one or more processors, cause the one or more processors to perform operations comprising based on a determination that a computer process should be shut down:
preventing each processing thread of a plurality of processing threads from spawning any new processing threads;
sending a dedicated signal to each processing thread of the plurality of processing threads, the dedicated signal indicating that each processing thread should stop current processing and wait for instructions;
retrieving information about all processing threads known to an operating system kernel;
determining whether a total number of all processing threads known to the operating system kernel is equal to a total number of processing threads that received the dedicated signal;
in response to a determination that the total number of all processing threads known to the operating system kernel is equal to a total number of processing threads that received the dedicated signal, repeating the retrieving information about all processing threads known to the operating system kernel and determining whether the total number of all processing threads known to the operating system kernel has changed; and
in response to a determination that the total number of all processing threads known to the operating system kernel has not changed, instructing all processing threads known to shut down resources of the computer process.

20. The non-transitory machine-readable medium of claim 19, wherein the computer process is a database process.
